(19) United States
(12) Patent Application Publication
(10) Pub. No.: US 2008/0208957 A1
(43) Pub. Date: Aug. 28, 2008

(54) Quarantine Over Remote Desktop Protocol

(75) Inventors: Lisen Ding, Redmond, WA (US); Meher Malakapalli, Sammamish, WA (US); Ashwin Palekar, Redmond, WA (US); Ido Ben-Shachar, Kirkland, WA (US); Venugopala Rao Moram, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/680,262

(22) Filed: Feb. 28, 2007

(51) Int. Cl. G06F 15/16; H04L 9/32

(52) U.S. Cl. 709/203; 726/5

(57) ABSTRACT

Described are systems and methods for implementing quarantine over a remoting protocol. The systems and methods verify whether remotely connected computing devices or client devices comply with specified system health requirements. This includes determining whether the remotely connected computing devices have correct security software installed, current operating system updates, correct configuration, etc.

### BACKGROUND

Network administrators are faced with the challenge of ensuring that computers that connect to and communicate on a private network are compliant with system health requirements. This challenge is compounded by the use of remote access connections to connect to a private network. For example, a terminal server can provide access to protected intranet resources to clients from outside an intranet firewall. Since these clients are remote, they are often exposed to attacks; however, they are not under direct control of network administrators. If a connecting remote client computer does not comply with the system health requirements, the private network can be exposed to attacks by malicious software such as viruses and worms.

### SUMMARY

This summary is provided to introduce simplified concepts of quarantine over a remoting protocol such as remote desktop protocol (RDP), which is further described below in the Detailed Description. This summary is not intended to identify essential features of the claimed subject matter, nor is it intended for use in determining the scope of the claimed subject matter.

In an embodiment, connection is made between multiple remote client computing devices and server through a communication protocol over a remoting protocol such as RDP. A minimum system health requirement is set, and a determination is made if any or all of the client computing devices meet the minimum system health requirement. Client devices that do not meet the minimum system health requirement may be quarantined.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

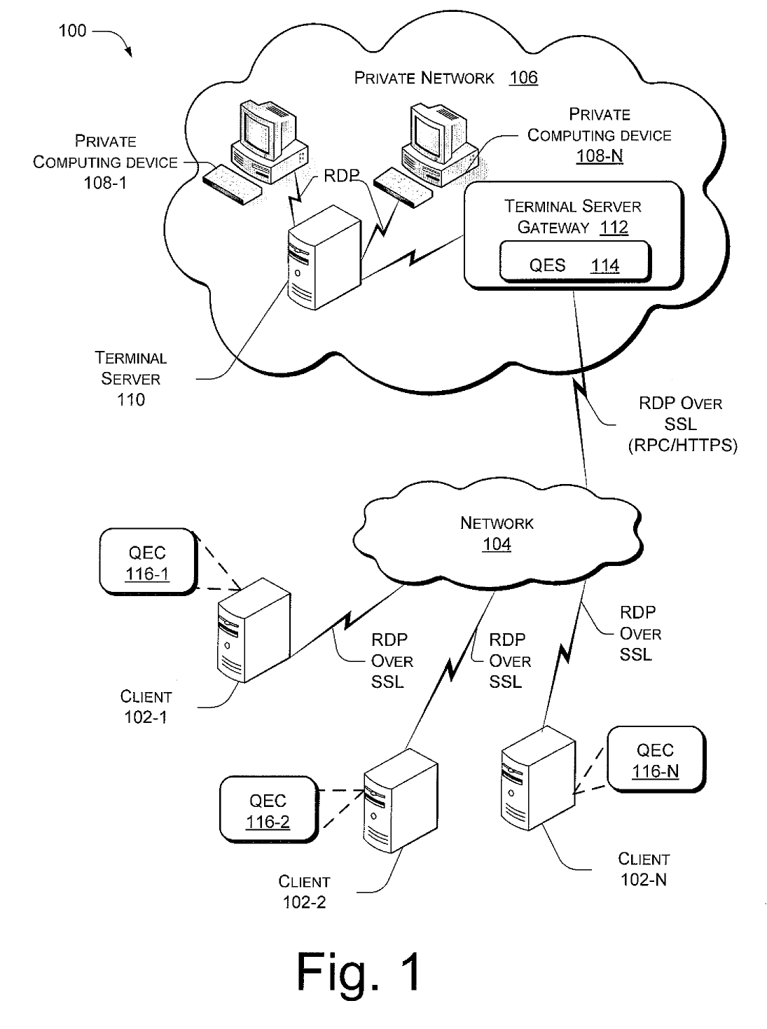

FIG. 1 is an illustration of an exemplary system that implements quarantine over a remoting protocol.

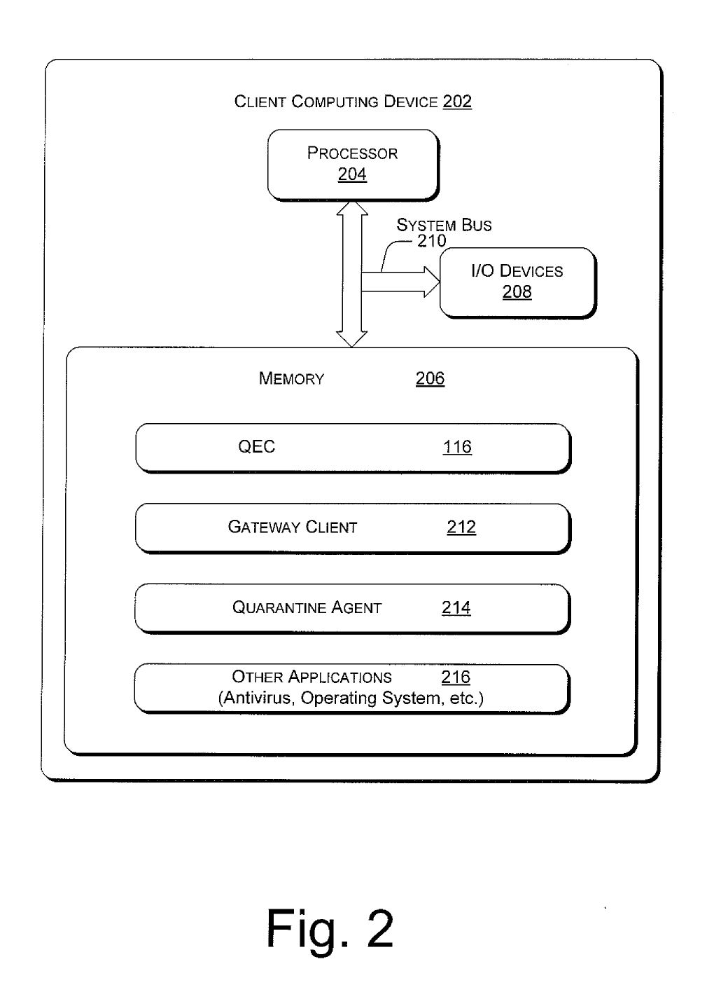

FIG. 2 is an illustration of an exemplary client computing device implementing a quarantine enforcement client.

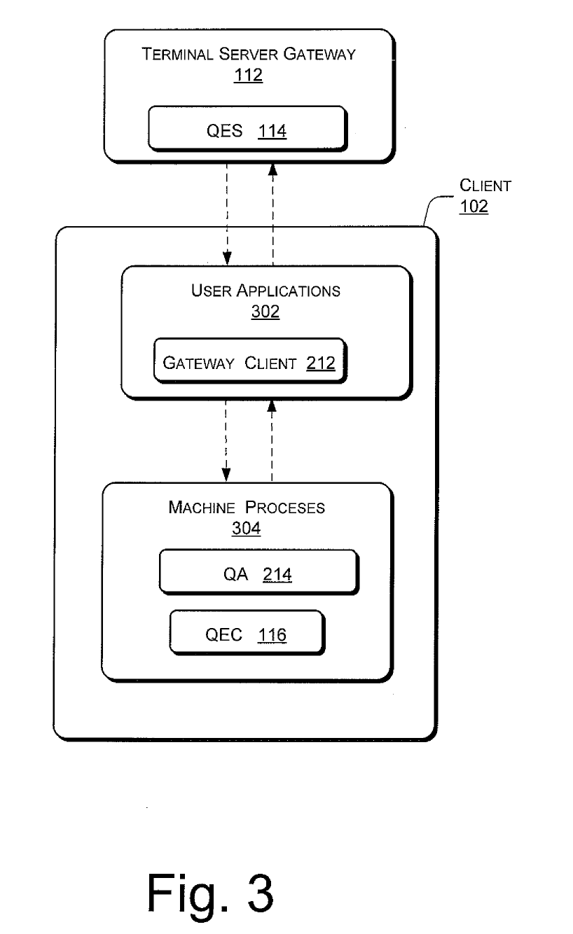

FIG. 3 is an illustration of an exemplary quarantine platform architecture.

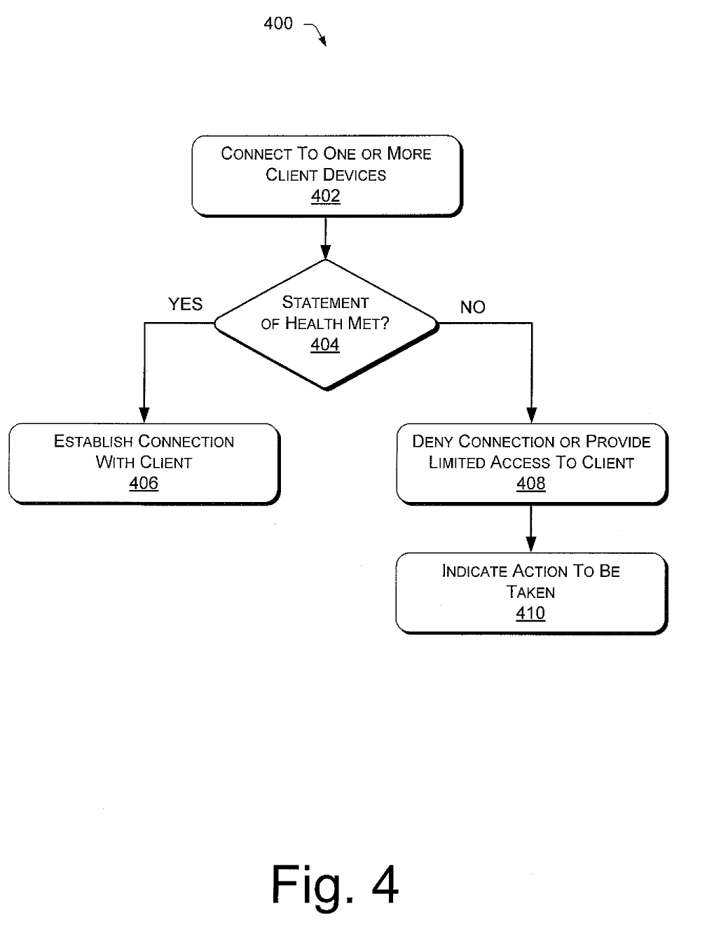

FIG. 4 is a flowchart of an exemplary method for quarantine over a remoting protocol.

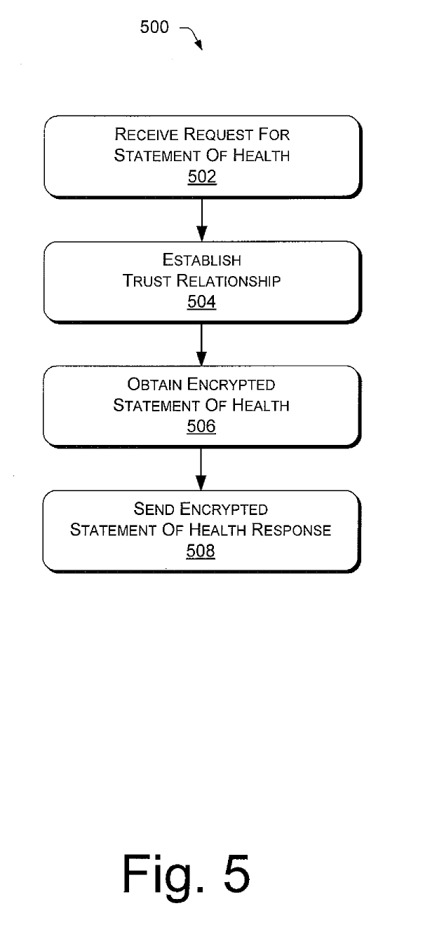

FIG. 5 is a flowchart of an exemplary method for determining if statement of health conditions of a client device are met.

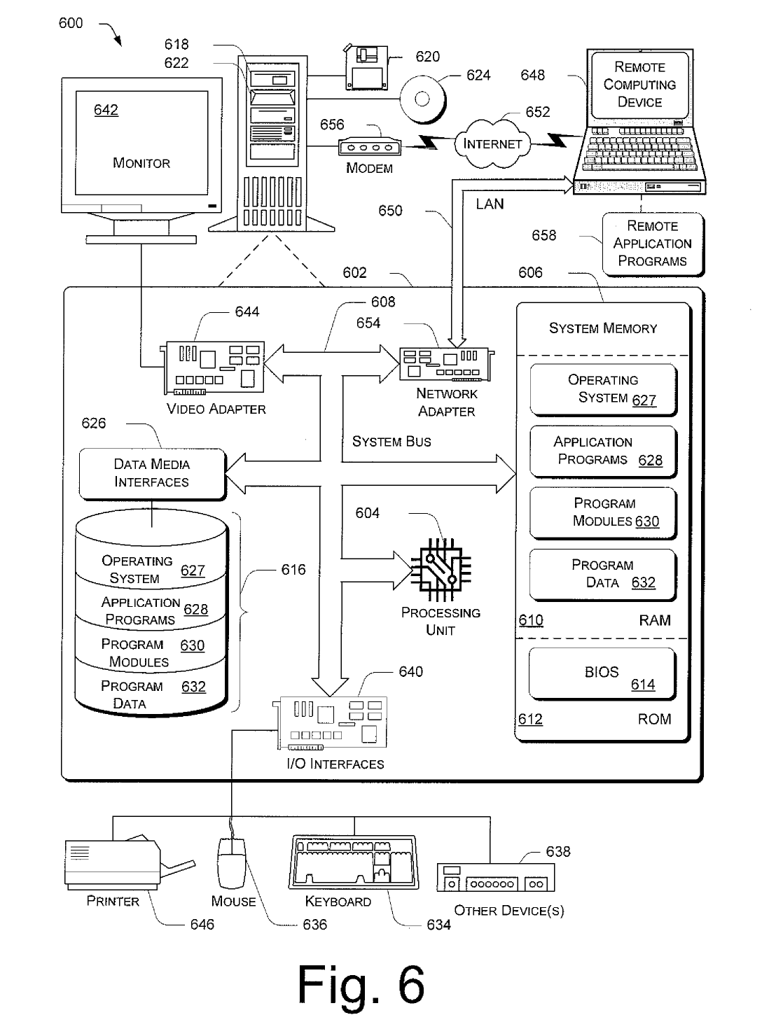

FIG. 6 is an illustration of an exemplary computer environment.

### DETAILED DESCRIPTION

The following disclosure describes systems and methods for implementing quarantine over remote desktop protocol. The systems and methods verify whether remotely connected computing devices or client devices comply with specified system health requirements. This includes determining whether the remotely connected computing devices (client devices) have correct security software installed (such as antivirus protection), current operating system updates, correct configuration (such as host-based firewalls enabled), etc. In addition, the systems and methods provide for remediation and quarantine of non-compliant client computing devices. The remediation measures can include providing security software, application updates, etc. Quarantine includes isolating the remotely connected computing device, providing no access or limited access to resources, etc.

In one system configuration, a quarantine platform can be deployed with a terminal server gateway (TSG) for quarantine over remoting protocol such as remote desktop protocol (RDP). The quarantine platform includes a quarantine enforcement client (QEC) and a quarantine enforcement server (QES). In one embodiment, the QES can include a combination of TSG and Network Policies server (NPS). The system can be configured so that the QEC can run in the context of a user application, such as Microsoft Terminal Services Client executive (mstsc.exe). An encryption and trust model can be provided so that an end-to-end trust relationship can be established between the QEC and the QES.

While aspects of described systems and methods for quarantine over remote desktop protocol can be implemented in any number of different computing systems, environments, and/or configurations, embodiments are described in the context of the following exemplary architectures.

### Exemplary System

FIG. 1 illustrates an exemplary system 100 for implementing quarantine over remote desktop protocol (RDP). The system 100 includes client computing devices 102-1 . . . 102-N associated through a network 104 with a private network 106. The client computing devices (clients) 102 may be any of a variety of conventional computing devices, including, for example, a server, a desktop PC, a notebook or portable computer, a workstation, a mainframe computer, a mobile computing device, an Internet appliance, a kiosk, etc.

The network 104 and/or the private network 106 may independently be a wireless or a wired network, or a combination thereof The network 104 and/or the private network 106 can be a collection of individual networks, interconnected with each other and functioning as a single large network (e.g., the Internet or an intranet). Examples of such individual networks include, but are not limited to, Local Area Networks (LANs), Wide Area Networks (WANs), and Metropolitan Area Networks (MANs).

In an exemplary implementation, the private network 106 can be a corporate network. The private network 106 includes, but is not limited to, private computing devices 108-1 . . . 108-N, a terminal server 110 and a terminal server gateway 112. The private computing devices 108 may be stand alone computing devices or may be part of a network such as a LAN or a WAN. The private computing devices 108 may also be associated with the terminal server 110 directly or through a network such as a LAN or a WAN.

The terminal server 110 provides remote computing devices (e.g., client 102) access to applications or data stored on the private computing devices 108 within the private network 106. The client 102 associates with the terminal server 110 through the terminal server gateway (TSG) 112.

The terminal server gateway 112 connects the clients 102 to the terminal server 110 over a communication protocol such as transport layer security (TLS), secure sockets layer (SSL), RPC (remote procedure call) over HTTPS (hypertext transfer protocol over encrypted SSL), etc. On top of the communication protocol, the client 102 communicates with the terminal server 110 through a remoting protocol such as RDP (remote desktop protocol). The remote desktop protocol can also be used by a private computing device 108 within the private network 106 to communicate with the terminal server 110.

The terminal server gateway 112 may include a quarantine enforcement server (QES) 114 to implement quarantine over RDP. In this example, the QES 114 is shown as residing on the terminal server gateway 112; however, it is understood that the QES 114 need not be hosted on the terminal server gateway 112. For example, the QES 114 could also be hosted on a storage medium communicatively coupled to the terminal server gateway 112. Furthermore, the QES 114 may be hosted in whole, or in part, on the terminal server gateway 112. For example, when the QES 114 includes a combination of functionalities of a network policies server (NPS) and terminal server gateway (TSG), the NPS part of the QES 114 can be hosted on a medium communicatively coupled to the terminal server gateway 112.

The QES 114 works with a quarantine enforcement client (QEC) 116. In this example, the QEC 116 is shown as residing on the client 102. The QEC 116 is implemented to perform quarantine over RDP. In operation, the QES 114 determines whether the client 102 complies with minimum system health requirements based on a statement of health or SOH received from the QEC 116. The minimum system health requirements can be specified by a network administrator and can include requirements for installation of security software (e.g., antivirus protection), installation of updated operating system, enabling host-based firewalls, etc. The SOH can include details about antivirus software and updates installed at the client 102, operating system updates installed at the client 102, etc.

Therefore, if the client 102 does not comply with the specified minimum system health requirements, the QES 114 can either deny permission to the client 102 or can provide for limited access to resources within the private network 106. In addition, the QES 114 can initiate remediation measures including providing relevant security software and updates to the client 102. Furthermore, the QES 114 can quarantine the client 102 until the client 102 complies with the minimum system health requirements.

### Exemplary Client Computing Device

An exemplary architecture of the client computing device or client 102 to implement quarantine over a remoting protocol such as RDP, is described in detail with reference to FIG. 2. The client 102 can include a processor 204, a memory 206, input/output (I/O) devices 208 (e.g., keyboard, display, and mouse), and a system bus 210 which operatively couples various components of the client 102.

The system bus 210 represents any of several types of bus structures, including a memory bus or memory controller, a peripheral bus, an accelerated graphics port, and a processor or local bus using any of a variety of bus architectures. Such bus architectures can include an industry standard architecture (ISA) bus, a micro channel architecture (MCA) bus, an enhanced ISA (EISA) bus, a video electronics standards association (VESA) local bus, a peripheral component interconnects (PCI) bus also known as a mezzanine bus, a PCI express bus, a universal serial bus (USB), a secure digital (SD) bus, or an IEEE 1394 (i.e., FireWire) bus.

Memory 206 can include computer-readable media in the form of volatile memory such as RAM, and/or non-volatile memory such as ROM or flash RAM. Memory 206 typically includes data and/or program modules for implementing quarantine over RDP, which are immediately accessible to and/or presently operated on by processor 204.

In an embodiment, memory 206 includes a QEC 116, a terminal server gateway client (gateway client) 212, a quarantine agent (QA) 214, and other applications 216.

In operation, once the client 102 requests permission from the terminal server gateway 112 to associate with the terminal server 110, the QES 114 sends a request for a statement of health (SOH) to the gateway client 212. The gateway client 212 requests for an authentication certificate from the QES 114. The authentication certificate can be in the form of a trust certificate (e.g., a corporate authority trust certificate). In response, the QES 114 sends the authentication certificate to the gateway client 212. The gateway client 212 then sends the authentication certificate along with a request for the statement of health (SOH) to the QEC 116. The QEC 116 validates or authenticates the authentication certificate. Upon authentication, a trust relationship is established between the QEC 116 and the QES 114.

The gateway client 212 may operate as a user application, such as Microsoft Terminal Services Commands executive (mstsc.exe), while the QEC 116 operates as a machine process or service. The gateway client 212 may use an application program interface or API, for example a command Get SOH( ), to communicate with the machine process QEC 116. The QEC 116 obtains a SOH regarding the client 102 from the QA 214. The QA 214 may also operate as a machine process or service. The QEC 116 encrypts the SOH based on the established trust relationship and sends the encrypted SOH to the gateway client 212. The gateway client 212 sends the encrypted SOH to the QES 114. The encrypted SOT can be decrypted by the QES 114 based on the trust relationship established earlier.

On decryption of the SOH, the QES 114 can determine whether the client 102 complies with the minimum system health requirements. The QES 114 then sends an encrypted statement of health response (SOHR) to the client 102. The SOHR can indicate whether the client is found to be compliant with the minimum system health requirements or not, and whether the client 102 can access the terminal server 110 or not.

The SOHR can also indicate the action to be taken in case of non-compliance. For example, if the QES 114 finds that the client 102 is non-compliant, the QES 114 can either deny access to the terminal server 110 or can permit limited access by the client 102 to the terminal server 110. The QES 114 can provide for remediation measures, such as providing software security applications, updates, operating system (OS) patches, antivirus software, etc. In addition, the QES 114 can quarantine the client 102, so that the client 102 can not access the terminal server 110 until the client 102 becomes compliant with the minimum system health requirements.

For purposes of discussion, the QES 114 and QEC 116 are described as being deployed at the TSG 112 and the client 102 respectively; however, it is to be understood that part of the QES 114 can be deployed independently from the TSG 112. Furthermore, the TSG 112 can function independently from part of the QES 114 and QEC 116. For example, the TSG 112 can be deployed without deploying the NPS part of QES 114 or QEC 116, and vice-versa. An exemplary architecture of a quarantine platform is discussed in detail below with reference to FIG. 3.

### Exemplary Quarantine Platform Architecture

FIG. 3 illustrates an exemplary quarantine platform architecture. A client 102 runs user applications 302, as well as machine processes 304. The user applications 302 include applications such as mstsc.exe. The machine processes 304 include processes such as systems management server (SMS), server update services (SUS), etc. A gateway client 212 can run in the context of the user applications 302 and can request permission from TSG 112 to communicate with terminal server 110.

QES 114 deployed at the TSG 112 can request the gateway client 212 to provide a SOH regarding the client 102. The gateway client 212 requests the QES 114 for an authentication certificate (e.g., a corporate authority trust certificate) to establish a trust relationship. The QES 114 can use previously stored internal data and/or may use services known in the art, such as HTTP APIs to obtain the authentication certificate. The QES 114 forwards the authentication certificate to the gateway client 212.

On receiving the authentication certificate, the gateway client 212 requests a QEC 116 to validate the authentication certificate and provide the SOH. Since the SOH is obtainable in the context of a machine process, the gateway client 212 uses local remote procedure call (LRPC) application program interface (API), for example a Get SOII( ) command, to call the QEC 116 which runs in the context of machine processes 304.

The QEC 116 obtains the SOW from quarantine agent or QA 214, which also runs in the context of machine processes 304. The QEC 116 encrypts the SOH based on the trust relationship established earlier and sends the encrypted SOH to the QES 114 through the gateway client 212.

The QES 114 decrypts the SOH based on the trust relationship established earlier and determines whether the client 102 complies with minimum system health requirements. In case the client 102 is found to be non-compliant, the QES 114 can send one or more SOH responses (SOHR) to the gateway client 212. The SOHR(s) can include denying access, limiting access, providing for remediation measures and quarantining the client 102.

The QES 114 can encrypt the SOHR based on the trust relationship before sending the SOHR to the gateway client 212. The gateway client 212 can use an API, such as a Send SOHR( ) command, to send the SOHR to the QEC 116 for implementation.

Thus the quarantine platform (i.e., QES 114 and QEC 116) makes it possible for user applications such as the gateway client 212 to query SOH from and send SOHR to QA 214 securely. It will be appreciated that the architecture explained above can be extended to quarantine the terminal server client 102 in case the terminal server 102 does not comply with the minimum system health requirements. In such a case, the terminal server client 102 can directly use the QEC 116 and the QA 214 on the client device. Moreover, in another embodiment, the NPS part of QES 114 can be deployed at the terminal server 110 and can function in a manner similar to that explained above to quarantine the terminal server gateway client 212.

### Exemplary Methods

Exemplary methods for implementing quarantine over a remoting protocol are described. These exemplary methods may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 4 illustrates an exemplary method 400 for implementing quarantine of a client device as described above. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 402, connection is performed to one or more client devices. The connection may be performed by a server through one or more networks as described above. Also as described above, the connection may implement a communication protocol through a remoting protocol such as RDP.

A determination is made if a statement of health or SOH condition or conditions is/are met. SOH conditions can include the following: assuring that correct security software are installed (such as antivirus protection) on client device(s); current operating system updates are installed on the client device(s); correct configuration (such as host-based firewalls enabled) are on the client device, etc.

Block 404 is further described in detail below in reference to FIG. 5. If the SOH condition(s) are met, following the YES branch of block 404, at block 406 full connection is established with a client or clients. The full connection includes access to applications and/or programs that may be available at or through the server (e.g., private networks provided by through the server).

If the SOH condition(s) are not met, following the NO branch of block 404, at block 408, a client or clients may be denied connections to the server or through the server. Alternatively, connection may continue with the server and the client or clients, with limited access to applications and/or programs that may be available at or through the server.

At block 410, action as to the non-complying (i.e., SOH conditions not met) client or clients is indicated or taken. The actions can include remediation measures which may provide relevant security software and updates to the client or clients to bring it/them into compliance with the SOH condition(s). The non-complying client or clients may also be placed in quarantine, until they become compliant with the SOH condition(s).

FIG. 5 illustrates an exemplary method 500 for determining if statement of health (SOH) condition(s) is/are met as described above. In particular, the method 500 may be implemented as block 404 of FIG. 4 above. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 502, a request for statement of health (SOH) is sent by a server and received by a client device along with an authentication certificate. In turn the client device may send the SOH to the server

At block 504, a trust relationship is established with the server and client. The trust relationship may use the authentication certificate to establish the trust relationship. In establishing the trust relationship, particular implementations may make use of known authentication services such http APIs described above.

At block 506, an encrypted SOH from the client device is received. In particular, the encryption may be based on the established trust relationship between server and client.

At block 508, an encrypted statement of health response (SOHR) is sent to the client. The SOHR can include rights to perform specific actions that can include denying access, limiting access, providing for remediation measures, and quarantining the client.

### Exemplary Computer Environment

FIG. 6 illustrates an exemplary general computer environment 600, which can be used to implement the techniques described herein, and which may be representative, in whole or in part, of elements described herein. The computer environment 600 is only one example of a computing environment and is not intended to suggest any limitation as to the scope of use or functionality of the computer and network architectures. Neither should the computer environment 600 be interpreted as having any dependency or requirement relating to any one or combination of components illustrated in the example computer environment 600.

Computer environment 600 includes a general-purpose computing-based device in the form of a computer 602. Computer 602 can be, for example, a desktop computer, a handheld computer, a notebook or laptop computer, a server computer, a game console, and so on. The components of computer 602 can include, but are not limited to, one or more processors or processing units 604, a system memory 606, and a system bus 608 that couples various system components including the processor 604 to the system memory 606.

The system bus 608 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 602 typically includes a variety of computer readable media. Such media can be any available media that is accessible by computer 602 and includes both volatile and non-volatile media, removable and non-removable media.

The system memory 606 includes computer readable media in the form of volatile memory, such as random access memory (RAM) 610, and/or non-volatile memory, such as read only memory (ROM) 612. A basic input/output system (BIOS) 614, containing the basic routines that help to transfer information between elements within computer 602, such as during start-up, is stored in ROM 612. RAM 610 typically contains data and/or program modules that are immediately accessible to and/or presently operated on by the processing unit 604.

Computer 602 may also include other removable/non-removable, volatile/non-volatile computer storage media. By way of example, FIG. 6 illustrates a hard disk drive 616 for reading from and writing to a non-removable, non-volatile magnetic media (not shown), a magnetic disk drive 618 for reading from and writing to a removable, non-volatile magnetic disk 620 (e.g., a “floppy disk”), and an optical disk drive 622 for reading from and/or writing to a removable, non-volatile optical disk 624 such as a CD-ROM, DVD-ROM, or other optical media. The hard disk drive 616, magnetic disk drive 618, and optical disk drive 622 are each connected to the system bus 608 by one or more data media interfaces 626. Alternately, the hard disk drive 616, magnetic disk drive 618, and optical disk drive 622 can be connected to the system bus 608 by one or more interfaces (not shown).

The disk drives and their associated computer-readable media provide non-volatile storage of computer readable instructions, data structures, program modules, and other data for computer 602. Although the example illustrates a hard disk 616, a removable magnetic disk 620, and a removable optical disk 624, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 616, magnetic disk 620, optical disk 624, ROM 612, and/or RAM 610, including by way of example, an operating system 627, one or more application programs 628, other program modules 630, and program data 632. Each of such operating system 627, one or more application programs 628, other program modules 630, and program data 632 (or some combination thereof) may implement all or part of the resident components that support the distributed file system.

A user can enter commands and information into computer 602 via input devices such as a keyboard 634 and a pointing device 636 (e.g., a “mouse”). Other input devices 638 (not shown specifically) may include a microphone, joystick, game pad, satellite dish, serial port, scanner, and/or the like. These and other input devices are connected to the processing unit 604 via input/output interfaces 640 that are coupled to the system bus 608, but may be connected by other interface and bus structures, such as a parallel port, game port, or a universal serial bus (USB).

A monitor 642 or other type of display device can also be connected to the system bus 608 via an interface, such as a video adapter 644. In addition to the monitor 642, other output peripheral devices can include components such as speakers (not shown) and a printer 646 which can be connected to computer 602 via the input/output interfaces 640.

Computer 602 can operate in a networked environment using logical connections to one or more remote computers, such as a remote computing-based device 648. By way of example, the remote computing-based device 648 can be a personal computer, portable computer, a server, a router, a network computer, a peer device or other common network node, and the like. The remote computing-based device 648 is illustrated as a portable computer that can include many or all of the elements and features described herein relative to computer 602.

Logical connections between computer 602 and the remote computer 648 are depicted as a local area network (LAN) 650 and a general wide area network (WAN) 652. Such networking environments are commonplace in offices, enterprise-wide computer networks, intranets, and the Internet.

When implemented in a LAN networking environment, the computer 602 is connected to a local network 650 via a network interface or adapter 654. When implemented in a WAN networking environment, the computer 602 typically includes a modem 656 or other means for establishing communications over the wide network 652. The modem 656, which can be internal or external to computer 602, can be connected to the system bus 608 via the input/output interfaces 640 or other appropriate mechanisms. It is to be appreciated that the illustrated network connections are exemplary and that other means of establishing communication link(s) between the computers 602 and 648 can be employed.

In a networked environment, such as that illustrated with computing environment 600, program modules depicted relative to the computer 602, or portions thereof, may be stored in a remote memory storage device. By way of example, remote application programs 658 reside on a memory device of remote computer 648. For purposes of illustration, application programs and other executable program components such as the operating system are illustrated herein as discrete blocks, although it is recognized that such programs and components reside at various times in different storage components of the computing-based device 602, and are executed by the data processor(s) of the computer

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

The above-described methods and system describe quarantine over a remoting protocol such as Remote Desktop Protocol. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A network system comprising:
a network;
one or more client devices connected to the network;
a server communicating to the client devices through a remoting protocol, wherein the server includes a quarantine enforcement server that quarantines one or more of the one or more client devices if minimum system health requirements are not met.

2. The network system of claim 1, wherein the client devices are connected to server through a communication protocol, and that the communicating between the server and client devices is through the remoting protocol over the communication protocol.

3. The network system of claim 1, wherein the minimum system health requirements are specified by a network system administrator.

4. The network system of claim 1, wherein the minimum system health requirements are based on a statement of health sent from the one or more client devices to the server.

5. The network system of claim 1 further comprising a private network that includes one or more private computing devices connected to the server.

6. A computing device comprising:
a memory;
one or more processors operatively coupled to the memory;
a quarantine enforcement client coupled to the one or more processors and memory that provides a statement of health of the computing device to a remote server.

7. The computing device of claim 6, wherein the client device is denied permission or given limited access to a private network through the server, based on the statement of health that is provided.

8. The computing device of claim 6, wherein the quarantine enforcement client validates an authentication certificate to establish a trust relationship with the server.

9. The computing device of claim 6 further comprising a gateway client that requests an authentication certificate from the server, and sends the authentication certificate to the quarantine enforcement client.

10. The computing device of claim 9, wherein the gateway client operates as a user application and the quarantine enforcement client operates as a machine process.

11. The computing device of claim 9, wherein the gateway client sends an encrypted version of the statement of health to the server.

12. The computing device of claim 9, wherein the gateway client receives sends statement of health response from the server.

13. The computing device of claim 6 further comprising a quarantine agent that provides the statement of health to the quarantine enforcement client.

14. A method comprising:
connecting to one or more computing devices through a communication protocol over a remoting protocol;
determining if the one or more computing devices meets a minimum system health requirement; and
quarantining computing devices that do not meet the minimum system health requirement.

15. The method of claim 14, wherein the determining includes sending a statement of health to the client devices, sending an authentication certificate to the client devices, and establishing a trust relationship based on the authentication certificate.

16. The method of claim 15, wherein the statement of health and authentication certificate are encrypted.

17. The method of claim 15 further comprising sending a statement of health response to the computing devices.

18. The method of claim 14, wherein quarantining includes remediation measures to place the computing devices that do not meet the statement of health into compliance.

19. The method of claim 14, wherein quarantining includes denying non-compliant computing devices access to other networks managed by the server.

20. The method of claim 14 further comprising providing full connection to client devices in compliance with the minimum system health requirement.
